(19) United States
(12) Patent Application Publication
(10) Pub. No.: US 2025/0314331 A1
(43) Pub. Date: Oct. 9, 2025

(54) Microvalve and Microvalve Array

(71) Applicant: Albert-Ludwigs-Universität Freiburg, Freiburg (DE)

(72) Inventors: Ardavan Shabanian, Freiburg (DE); Anjan Bhat Kashekodi, Freiburg (DE); Peter Woias, Freiburg (DE); Frank Goldschmidtböing, Ortenberg (DE)

(73) Assignee: Albert-Ludwigs-Universität Freiburg, Freiburg (DE)

(21) Appl. No.: 19/244,369

(22) Filed: Jun. 20, 2025

Related U.S. Application Data
(63) Continuation of application No. PCT/EP2023/087343, filed on Dec. 21, 2023.

(30) Foreign Application Priority Data
Dec. 21, 2022 (EP) 22215301.7

(51) Int. Cl. F16K 99/00

(52) U.S. Cl. CPC F16K 99/0048; F16K 99/0015; F16K 99/0028

(57) ABSTRACT

A microvalve includes a base body, a deflectable membrane, and an actuating element supported by the base body and contacting the deflectable membrane. The base body has a cavity, at least one first opening, and at least one second opening. Each of the at least one first opening and the at least one second opening extend into the cavity. The deflectable membrane separates the cavity into a first chamber and a second chamber. The deflectable membrane has at least one through-hole extending between the first chamber and the second chamber. The actuating element is operable to deflect the membrane to move between at least two positions.

### CROSS-REFERENCE TO RELATED APPLICATIONS

This application is a continuation of PCT International Application No. PCT/EP2023/087343, filed on Dec. 21, 2023, which claims priority under 35 U.S.C. § 119 to European Patent Application No. 22215301.7, filed on Dec. 21, 2022.

### FIELD OF THE INVENTION

The present disclosure relates to a microvalve and a microvalve array comprising one or more such microvalves designed according to the present disclosure.

### BACKGROUND

Microvalves are known for controlling the flow of fluids, such as gases and liquids, in many applications from aerospace, automotive, Lab-on-a-chip and oil industry, to pharmaceutical, diagnostic, and medical applications. For instance, in the area of medical applications, microvalves can be part of pumping systems to administrate and dose small amounts of fluids, and in the automotive industry they can be utilized to provide pneumatic control in comfort seat systems.

Furthermore, it is known to provide a controlled flow of gas to inflate and deflate arrays of inflatable air cushions. Such air cushions are e.g. used for adapting the contour of car seats, aircraft seats, or the like to the need of a user. For instance, these air cushions may be attached to the seat suspension. By filling and emptying the air cushions, the curvature can be varied to the front. By varied filling of the upper or lower cushions, the curvature is shifted up or down. In addition, an array of cushions can be used to provide various massaging functions for the passenger.

Furthermore, it is known to provide a controlled flow of gas to apply pressure, or alternating under pressure and over-pressure, to an outlet. Such outlet can be used in for example biological applications to apply alternative pressures to cell membranes or cell cultures in microplates, such as 96-well plates. However, a high number of valves has to be used for this application and it is therefore vital that each of these valves is particularly effective, energy efficient, and noiseless.

Consequently, there is a need for a microvalve that efficiently controls a fluid flow, is energy saving and furthermore operates preferably noiselessly.

### SUMMARY

The present disclosure is based on the idea to provide a microvalve with a buckling membrane that has at least one through-hole provided therein. Such membranes will also be called fenestrated in the following; the through-holes may also be referred to as apertures, openings, windows, or passages.

In particular, a microvalve according to the present disclosure comprises a base body with a cavity and at least one first opening and at least one second opening, each opening extending into the cavity, a deflectable membrane, which separates the cavity into a first chamber and a second chamber, an actuating element, which is supported by the base body and which contacts the deflectable membrane and is operable to deflect the membrane to move between at least two positions, wherein the deflectable membrane comprises at least one through-hole extending between the first chamber and the second chamber.

It should be noted that, according to the present disclosure, the deflectable membrane and the actuating element together are also referred to as an actuator which is operable to open and close at least one opening.

An advantage of providing at least one through-hole in the membrane can be seen in the fact that pressure is partially compensated on both sides of the actuator. Therefore, the actuator can operate against higher ranges of pressure, or smaller actuation energies are required to close against a certain pressure. Further, a particular space saving geometry can be achieved.

Moreover, because the fluid can stream through the membrane, the microvalve can be built in way that the inlet is arranged on one side of the membrane and the outlet on the other. Such a geometry is e.g. advantageous for controlling the flow along a fluidic pathway such as a pipe. In particular, according to an advantageous example, the at least one first opening is arranged to extend into the first chamber, and the second opening is arranged to extend into the second chamber.

According to a further advantageous example, at least one of the at least one first opening and at least one second opening is provided with a valve seat, and wherein the deflectable membrane is operable to touch the valve seat for closing the respective at least one first opening and/or at least one second opening in one of the positions. Providing a valve seat improves the leak tightness of the closed valve. Moreover, the required deflection of the membrane is decreased, if the valve seat forms a protrusion extending towards the membrane.

The valve seat may be formed of a rigid material, but may be formed from an elastic, compressible material such as silicone. However, it should be noted that the membrane may also close an opening without a valve seat arranged around the opening. Moreover, the valve seat may also be attached to the membrane's surface.

In particular when arranging the membrane in a way that not only a pressure compensation is achieved by the fenestrated membrane, but that a fluid path leads across the membrane, it is advantageous that the at least one through-hole is arranged so as to remain unobstructed in all the positions.

As mentioned above, instead of merely bending, the membrane is advantageously a membrane which is deflected by buckling or a combination of bending and buckling, both of which will be referred to as buckling.

For actuating such a membrane, the actuating element may comprise at least one ring-shaped actuation of the piezoelectric drive element. The use of a buckling membrane actuated by a ring-shaped piezoelectric drive element has the advantage that the membrane can be deflected by a much larger distance using the same energy as compared with known bending actuating elements. Because only at the periphery of the membrane a compressing force has to be applied for the membrane to buckle, the piezoelectric drive element does not have to be perforated. Therefore, the mechanical characteristics of the actuating element are not influenced by the fenestration.

In order to facilitate the buckling movement of the membrane, the piezoelectric drive element may be supported around a peripheral region so as to be moveable. For instance, the piezoelectric drive element may be held between two elastic bearings, such as O-rings or a similar support.

According to a further advantageous example, these flexible and/or elastic supports can be compressed within a certain range while still maintaining their flexibility and thus allowing the movement of the actuator. This allows for a continuous support within the full range of actuation. In addition, this flexible range then can be used during the assembly process, by shifting the initial position of actuator in the device and thereby adjusting for example the size of the opening gap of the valve.

This shifting possibility of the actuator by compressing the flexible rings without influencing its behavior can also be used to compensate for the fabrication and/or assembly tolerances, regardless of whether they originate from surface roughness, tilts, tolerances, thermal shrinkages and expansions, aging of components, or any other forms of imperfections. The flexible support of the actuator can compensate for these imperfections and for example create a more even support and sealing surface, thus providing the required geometrical, mechanical, and fluidical properties.

Furthermore, the possibility to shift the actuator during assembly and thereby adjusting the opening gap of the valve can be used to calibrate the valve for the required performance, such as flowrate, pressure, or response time. For example, calibrating the valve to have a bigger initial gap can increase the final allowable flowrate of the valve, while calibrating the valve to have a smaller gap can increase the pressure tolerance of the valve.

According to a further advantageous example, the at least one through-hole is arranged in a region not covered by the piezoelectric drive element and outside the center of the deflectable membrane. This geometry advantageously allows to control the flow of a fluid between two opposing openings, and ensures a maximum efficiency because the openings to be closed can be arranged at the position of the maximum membrane deflection. In addition, it is advantageous as both sides of the actuator are exposed to the pressure. This reduces the net pressure against which the actuator needs to operate. Therefore, using the same energy, the valve can operate against higher pressures.

Furthermore, the compensated pressure across the actuator facilitates the proportional operation of the valve. Unlike the switching valves which only provide the final opening or closing states, the proportional valves can provide states in between, thus for example control the final outlet flowrate of a valve under the same applied pressure. This enables for a wider range of applications, such as applying smooth pressures to the cell cultures, canceling the variable boundary conditions, or delivering a certain flowrate/pressure according to a control signal.

The pressure compensation together with the flexible support of the elastic rings during a wide range of operation and combination of bending and buckling can enhance the proportionality of the valve in various aspects such as precision, control, as well as operation range.

In order to precisely control the buckling movement of the membrane, the actuating element may comprise a first piezoelectric drive element and a second piezoelectric drive element, wherein the deflectable membrane is supported between the first piezoelectric drive element and the second piezoelectric drive element. Depending on the applied mechanical forces, the membrane can be deflected in two directions. Due to the fenestration, a particularly fast buckling movement is possible.

According to a further advantageous example of the present disclosure, two first openings extend into the first chamber, wherein one second opening extends into the second chamber, wherein the second opening may be arranged opposite to one of the first openings, and wherein the second opening and the opposing first opening are provided with a valve seat, each valve seat being touchable by the deflectable membrane. In this manner, a 3/2 way valve can be achieved with only one actuator. As this is generally known, an x/y way valve (x, y being integers greater than 2) signifies a valve assembly with x ports and y states.

Advantageously, in this configuration pressure is partially compensated on both sides of the actuator. Therefore, the actuator can operate against higher ranges of pressure, or smaller actuation energies are required to close against a certain pressure. Various configurations of the three ports can be achieved for the optimal performance, depending on the pressure required and stored at each port.

As mentioned above, microvalves according to the present disclosure may advantageously be used as parts of arrays that control the distribution of fluids, for instance air. An advantage of the use of one or more microvalves according to the present disclosure can be seen in the fact that the microvalve can be operated efficiently, accurately, and almost noiselessly. The one or more microvalves may be arranged adjacently, i.e. as an array of microvalves lying essentially within one plane. Alternatively, or additionally, some or all of the microvalves may also be arranged as a stack.

By varying the number of actuators and by providing different interconnections between the various openings in the base body, a variety of valve assemblies, e.g. a 5/2 valve, or a 3/3 valve can be realized. Valve assemblies with more than one deflectable membrane with integrated interconnections will be referred to as a manifold in the following. An assembly of more than one microvalve is also called a microvalve array.

According to an advantageous example, the microvalve array may comprise at least a first microvalve and a second microvalve, wherein the first and the second microvalves are interconnected by a fluid path connected to their respective first openings, which can be closed by the movement of the respective deflectable membranes. Thus, a 5/2 way valve assembly can be realized. The two microvalves can also be arranged in a stack, to realize a compact 5/2 valve in a small footprint.

A particularly efficient control of the fluidic flow with an exceptionally small geometry can be achieved when the first and the second microvalves each comprise two second openings, wherein the deflectable membranes of each of the first and second microvalves is moveable to close either the respective first opening or the second opening arranged opposite to the first opening.

Furthermore, for realizing a 3/3 valve assembly, the microvalve array may comprise at least two microvalves which are interconnected by a fluid path connected to their respective second openings, which cannot be closed by the movement of the respective deflectable membranes.

For some applications, the microvalve array may additionally comprise at least one microvalve which has a deflectable membrane without a through-hole.

### BRIEF DESCRIPTION OF THE DRAWINGS

The accompanying drawings are incorporated into the specification and form a part of the specification to illustrate several embodiments of the present invention. These drawings, together with the description, serve to explain the principles of the invention. The drawings are merely for the purpose of illustrating examples of how the invention can be made and used, and are not to be construed as limiting the invention to only the illustrated and described embodiments. Furthermore, several aspects of the embodiments may form-individually or in different combinations-solutions according to the present invention. The following described embodiments thus can be considered either alone or in an arbitrary combination thereof. Further features and advantages will become apparent from the following more particular description of the various embodiments of the invention, as illustrated in the accompanying drawings, in which like references refer to like elements, and wherein:

FIG. 1 is a schematic sectional view of a microvalve in a first state;

FIG. 2 is a schematic sectional view of the microvalve of FIG. 1 in a second state;

FIG. 3 is a schematic sectional view of a further microvalve in a first state;

FIG. 4 is a schematic sectional view of the microvalve of FIG. 3 in a second state;

FIG. 5 is a schematic sectional view of a microvalve manifold in a first state;

FIG. 6 is a schematic sectional view of the microvalve manifold of FIG. 5 in a second state;

FIG. 7 is a schematic sectional view of a further microvalve manifold in a first state;

FIG. 8 is a schematic sectional view of the microvalve manifold of FIG. 7 in a second state; and

FIG. 9 is a schematic sectional view of the microvalve manifold of FIG. 7 in a third state.

### DETAILED DESCRIPTION

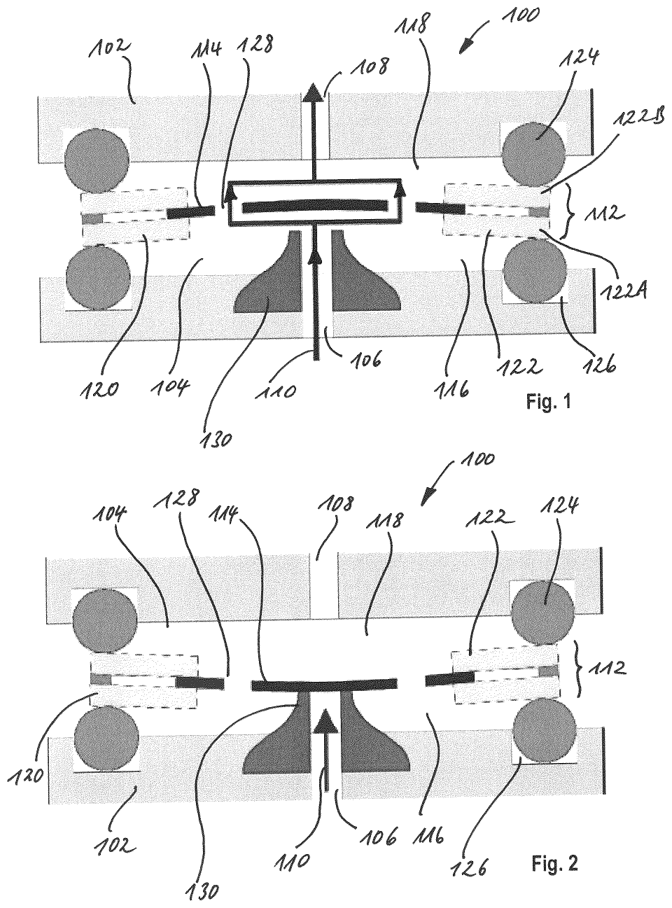

The present invention will now be explained in more detail with reference to the Figures and firstly referring to FIG. 1. This Figure shows in a schematic sectional view a first example of a microvalve 100 which represents a 2/2 way valve, i.e., a microvalve having 2 ports and 2 states. It should be noted that in all the Figures of the present disclosure, dimensions are not drawn to scale. in particular, the height is often shown exaggerated compared to the lateral dimensions in order to more clearly show the principles of the geometry.

The microvalve 100 and has a base body 102 with a cavity 104 formed therein. A first opening 106 and a second opening 108 extend into the cavity 104 and allow for a fluid stream 110 to enter and leave the cavity 104. As mentioned above, the fluid may be gas, such as air, or any liquid. The openings 106, 108 are also referred to as ports.

For controlling the fluid stream 110, the microvalve 100 comprises an actuator 112. According to the present disclosure, the actuator 112 comprises a deflectable membrane 114 which separates the cavity 104 into a first chamber 116 and a second chamber 118. The actuator 112 further comprises an actuating element 120 which is operable to cause the membrane 114 to move.

According to an advantageous example of the present disclosure, the actuator 112 is of the kind that uses a buckling membrane 114. To deflect the membrane 114, the actuator 112 comprises a piezoelectric drive element 122, which may be ring-shaped, and which exerts radial forces on the membrane 114, which causes the membrane 114 to be deflected with the snapping buckling movement. This kind of actuation has the advantage that the amount of deflection for a given amount of energy applied by the actuating element 120 is much higher than with an actuator 112 where the actuating element exerts only bending forces that are orthogonal to the plane of the membrane.

In the present example, the piezoelectric drive element 122 comprises a first drive element 122A and as second drive element 122B. As shown in FIG. 1, the first and second drive elements 122A, 122B are attached to opposing surfaces of the membrane 114. By actuating the first and second drive elements 122A, 122B, different tensile stress can be applied to the peripheral region of the membrane 114, causing it to buckle. In the shown example, the piezoelectric drive element 122 is supported movably in a flexible bearing 124. The flexible bearing 124 may for instance be formed by two O-rings made from an elastic material, which are held in corresponding notches 126 of the base body 102. Any other suitable type of bearing may of course also be used. Due to the flexible mounting of the actuator 112, the piezoelectric drive element 122 may tilt to follow the membrane 114 in its movement.

The first and second drive elements 122A, 122B are arranged at the membrane 114 so as to engage only in a peripheral region of the membrane 114. The membrane 114 is not present in the area where the flexible bearing 124 engages with the first and second drive elements 122A, 122B.

According to the present disclosure, the membrane 114 has one or more through-holes 128. These through-holes 128 have firstly the advantage that they provide a pressure compensation between the first chamber 116 and the second chamber 118. A further important advantage of providing at least one through-hole 128 in the membrane 114 is that it is possible to control the flow of a fluid along a linear path, such as in a pipe. As can be seen from FIG. 1, the first opening 106 serves as an inlet for the fluid stream 110 which then passes from the first chamber 116 through the through-hole elements 128 into the second chamber 118. The second opening 108 serves as an outlet for the fluid stream 110 by connecting the first opening 106 and the second opening 108 with suitable piping, the flow through a linear fluidic pathway can be controlled by opening and closing the valve 100.

The microvalve 100 comprises a valve seat 130 which is arranged around the first opening 106. Advantageously, the valve seat 113 is fabricated from an elastic material, so that it is compressible. In the first state shown in FIG. 1, the membrane 114 is deflected upwardly towards the second opening 108 so that the fluid stream 110 can enter through the first opening 106 into the first chamber 116 and through the through-holes 128 into the second chamber 118. The second opening 108 serves as an outlet. If a pump or any other pressure difference between the inlet and the outlet drives the fluid stream 110, the fluid stream 110 can easily flow in the direction indicated by the arrows shown in FIG. 1.

FIG. 2 illustrates a second state of the microvalve 100 where the membrane 114 is actuated to be moved towards the valve seat 130. In this position, the central part of the membrane 114 is in contact with a peripheral part of the valve seat 130, thus sealing the first opening 106. Consequently, the fluid stream 110 is blocked by the microvalve 100.

The mechanical characteristics of the membrane 114 and its bearing via the piezoelectric drive element 122 in the base body 102 can be chosen in a way that the valve is bi-stable. This means that energy has to be applied to the piezoelectric drive element 122 only for changing the position of the membrane 114 from the first state shown in FIG. 1 to the second state shown in FIG. 2 and back again, but that the piezoelectric drive element 122 does not have to be particularly energized to maintain any of the two positions. This allows for a particularly low energy operation of the microvalve 100.

Moreover, due to the presence of the apertures 128, a very rapid effortless movement of the membrane 114 is possible.

As mentioned above, these flexible and/or elastic supports 124 can be compressed within a certain range while still maintaining their flexibility and thus allowing the movement of the actuator 112. This allows for a continuous support within the full range of actuation. In addition, this flexible range then can be used during the assembly process, by shifting the initial position of actuator 112 in the device and thereby adjusting for example the size of the opening gap of the valve 100.

This shifting possibility of the actuator 112 by compressing the flexible rings 124 without influencing its behavior can also be used to compensate for the fabrication and/or assembly tolerances, regardless of whether they originate from surface roughness, tilts, tolerances, thermal shrinkages and expansions, aging of components, or any other forms of imperfections. The flexible support of the actuator can compensate for these imperfections and for example create a more even support and sealing surface, thus providing the required geometrical, mechanical, and fluidical properties.

Furthermore, the possibility to shift the actuator 112 during assembly and thereby adjusting the opening gap of the valve 100 can be used to calibrate the valve 100 for the required performance, such as flowrate, pressure, or response time. For example, calibrating the valve to have a bigger initial gap can increase the final allowable flowrate of the valve, while calibrating the valve to have a smaller gap can increase the pressure tolerance of the valve.

The at least one through-hole 128 is arranged in a region not covered by the piezoelectric drive element and outside the center of the deflectable membrane 114. This geometry advantageously allows to control the flow of a fluid between two opposing openings, and ensures a maximum efficiency because the openings to be closed can be arranged at the position of the maximum membrane deflection. In addition, it is advantageous as both sides of the actuator 112 are exposed to the pressure. This reduces the net pressure against which the actuator 112 needs to operate. Therefore, using the same energy, the valve 100 can operate against higher pressures.

Furthermore, the compensated pressure across the actuator 112 facilitates the proportional operation of the valve. Unlike the switching valves which only provide the final opening or closing states, the proportional valves can provide states in between, thus for example control the final outlet flowrate of a valve under the same applied pressure. This enables for a wider range of applications, such as applying smooth pressures to the cell cultures, canceling the variable boundary conditions, or delivering a certain flowrate/pressure according to a control signal.

The pressure compensation together with the flexible support of the elastic rings 124 during a wide range of operation and combination of bending and buckling can enhance the proportionality of the valve 100 in various aspects such as precision, control, as well as operation range.

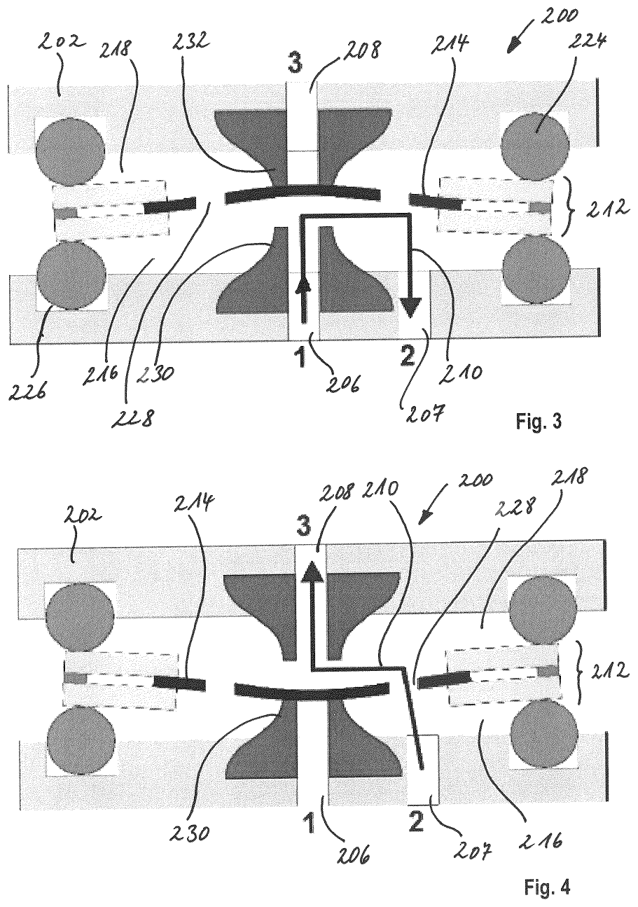

FIGS. 3 and 4 illustrate a further advantageous example of a microvalve 200. The microvalve 200 is a 3/2 way valve, i.e., it has 3 ports and 2 states. The actuator 212 is structured and supported in the base body 202 in the same way as the actuator 112 explained above with reference to FIGS. 1 and 2. The 3/2 way valve can be used for example in combination to a pressure source (such as a pump) supplying pressure to its inlet port 1. The valve then can apply the pressure on a target outlet (such as a reservoir or cell membrane) connected to port 2 in the first state, and then relieve the pressure by connecting this outlet (port 2) to the vent (port 3) in the second state.

The microvalve 200 differs from the microvalve 100 explained referring to FIGS. 1 and 2 in that a first valve seat 230 is arranged around the first opening 206 (also called port 1) and a second valve seat 232 is provided around the second opening 208 (port 3). Thus, the membrane 214 can be actuated between a first position (FIG. 3) and a second position (FIG. 4), and in both positions seals off one port. In the first position, the membrane 214 it is in contact with the second valve seat 232, sealing the second opening 208 (port 3). In the second position, the membrane 214 is in contact with the first valve seat 213 thus closes the first opening 206 (port 1).

Furthermore, in the base body 202 a third opening 207 (port 2) is provided which extends into the first chamber 216. Consequently, as shown in FIG. 3, in the first state the fluid stream 210 can enter the first chamber 216 through the opening 206 (port 1) and leaves the first chamber 216 through the third opening 207 (port 2). Because the second opening 208 is closed by the membrane 214 being pressed against the second valve seat 232, no fluid stream 210 leaves the microvalve 200 through the second chamber 218.

On the other hand, in the second state which is shown in FIG. 4, the first opening 206 (port 1) is sealed by the membrane 214 being pressed against the first valve seat 230. A fluid stream 210 may therefore enter through the third opening 207 (port 2), and pass through the fenestration 228 into the second chamber 218. The fluid stream 210 leaves the microvalve 200 in this state through the second opening 208 (port 3). Advantageously, with this geometry a 3/2 way valve can be achieved by using only one actuator 212. The pressure is partially compensated on both sides of the actuator 212. Therefore, the actuator 212 can operate against higher ranges of pressure, or smaller actuation energies are required to close against a certain pressure. Of course, various different configurations of the 3 ports can be used for achieving the optimal performance, depending on the pressure required and stored at each port.

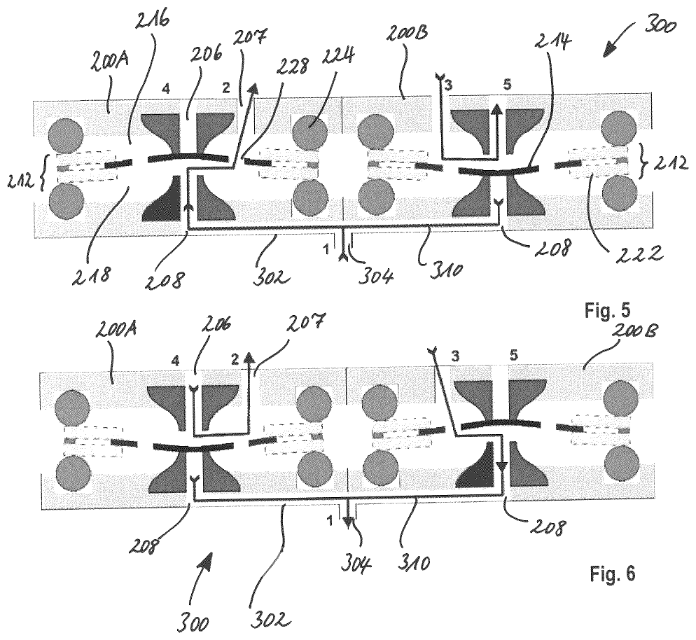

By using more than one microvalve and combining them with inter base body interconnections, valve assemblies (or manifolds) with a much complex a flow pattern can be realized. A first example of a micro valve manifold 300 is shown in FIGS. 5 and 6.

In particular, FIG. 5 shows a first state of a 5/2 way valve assembly. FIG. 6 shows a second state of the 5/2 way valve assembly. The micro valve manifold 300 comprises two microvalves 200 as explained with reference to FIGS. 3 and 4. The first microvalve 200A is arranged adjacent to a second microvalve 200B. It should be noted that compared to the representation shown in FIGS. 3 and 4, the two microvalves 200A, 200B are depicted turned by 180°. The first opening 206 of the first microvalve 200A forms port 4 and the third opening 207 forms port 2. In the state shown in FIG. 5, the membrane of the first microvalve 200A is deflected to seal port 4. Thus, port 2 is connected via the through-hole 228 with the second chamber 218. For interconnecting the two microvalves 200A, 200B, the micro valve manifold 300 comprises a fluid path 302, which is in fluidic contact with the second openings 208 of the two microvalves 200A, 200B. A port 304 (referred to as port 1 in FIGS. 5 and 6) is provided at the fluid path 302 to allow a fluid stream 310 to enter or leave the microvalve manifold 300.

Both membranes 214 of the microvalves 200A, 200B are provided with through-holes 228. The membranes 214 are operated to move synchronously in opposite directions compared to each other. In the first state shown in FIG. 5, the membrane 214 of the first microvalve 200A, i.e., the first opening 206, is unblocked and fluid can flow from port 1 through the fluid path 302 into the second chamber 218. The fluid stream 310 then passes through the through-hole 228 into the first chamber 216 and leaves the microvalve manifold 300 through the third opening 207 (port 2). At the same time, the membrane 214 of the second microvalve 200B closes its second opening 208 so that ports 3 and 5 are fluidically interconnected.

With the microvalve manifold 300, a 5/2 way valve assembly can be realized by using two actuators, both having fenestrations, and an inter base body connector. The pressure is partially compensated on both sides of the actuators. Therefore, the actuators can operate against higher ranges of pressure, or smaller actuation energy is required to close against a certain pressure. Various configurations of the five ports can be provided to achieve optimal performance, depending on the pressure and flow rate required at each port.

A 5/2 way valve can be used to switch between the vacuum and pressure ports of a pump for flow switching applications. To do so, in one state, the pressure port of the pump is connected to the target outlet, while the vacuum of the pump should be connected to the vent. In the second state, the vacuum port of the pump is connected to the target outlet, while the pressure port of it is connected to vent. The applications can range from Intermittent Pneumatic Compression, preventing deep vein thrombosis, pick-and-place machines, pipetting robots, etc.

As mentioned above, the individual microvalves do not have to be arranged side by side as this is shown in FIGS. 5 and 6, but may also be stacked upon one another. Such a geometry would lead to a much more compact construction of the microvalve manifold 300.

Furthermore, also more than two microvalves may be combined for forming the microvalve manifold. 5 It is also not necessary that all of the employed actuators use a membrane having through-holes therein.

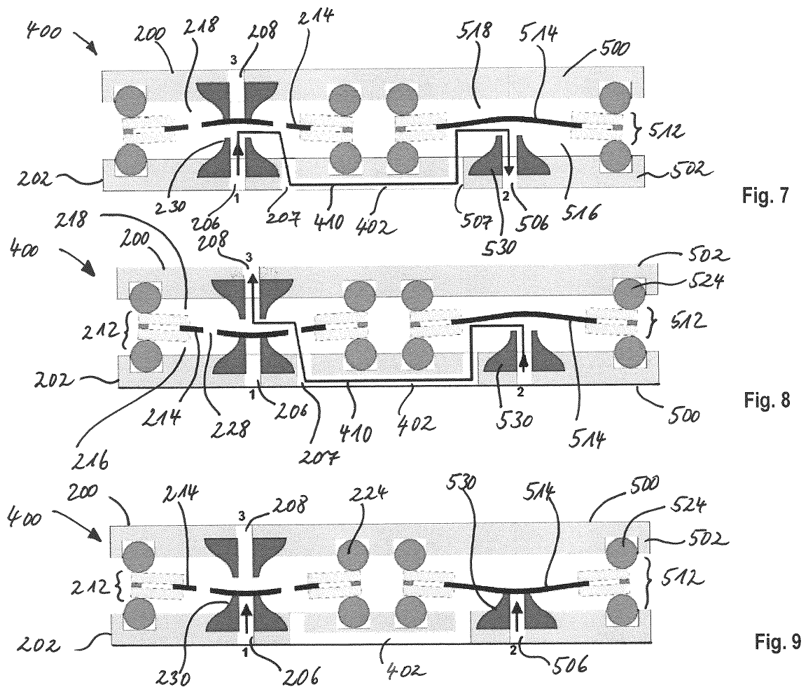

An example of a microvalve manifold 400, which forms a 3/3 way valve (i.e., having 3 ports and 3 states) will be explained in the following, referring to FIGS. 7 to 9. Each of the FIGS. 7, 8, and 9 show one of the three different states. Applications of a 3/3 way valve include systems that not only require the two states of pressurizing and venting an outlet port, but also are able to maintain the previous pressure status of the outlet port.

As can be seen from FIGS. 7, 8, and 9, the microvalve manifold 400 is essentially a combination of a microvalve 200 as explained with reference to FIGS. 3 and 4, and a microvalve 500 having a membrane, which may be without through-holes. This example is shown in the drawing. Of course, although not shown in this Figure, the membrane may comprise holes for compensating the pressure. Apart from the lacking apertures in the deflectable membrane 514, the actuator 512 is supported and works identical to the actuator 212 described with reference to FIGS. 3 and 4.

The two microvalves 200, 500 are interconnected with each other by means of a fluid path 402. This fluid path 402 is fluidically connected to the third openings 207, 507 which thus do not form a port.

In the first state (FIG. 7), both membranes 214, 514 are actuated to be deflected towards the respective second chambers 218, 518. Thus, the first openings 206, 506 which are surrounded by valve seats 230, 530, are unblocked, so that a fluid stream 410 can flow from the first opening 206 (port 1) via the third opening 207 and the fluid path 402 into the third opening 507 of the second microvalve 500 and out through the first opening 506 (port 2). At the same time, the second opening 208 (port 3) of the first microvalve 200 is closed by the membrane 214 touching and sealing the valve seat 232.

In this state, a fluid stream 410 can be channeled from port 1 through the microvalve fluid path 402 towards port 2.

In the second state (which is shown in FIG. 8), the membrane 514 still leaves the port 2 open, while the membrane 214 is actuated so that it buckles towards the first opening 206 (port 1).

Because the first microvalve 200 has openings 228, the fluid stream 410 which enters through the third opening 207 into the first chamber 216, can pass into the second chamber 218. The fluid stream 410 can exit the micro valve manifold 400 through the second opening 208 (port 3), provided the fluid is driven by a pressure difference or pump. Thus, a fluid stream 410 is guided to flow from port 2 to port 3.

Finally, FIG. 9 shows the third state, in which both membranes 214, 514 are in sealing contact with the first valve seats 230, 530. Thus, no fluid can enter into any of the ports 1 and 2 and the microvalve manifold 400 blocks completely.

In summary, with the microvalve manifold 400 it is possible to provide a 3/3 way valve assembly using two actuators 512, 212 and an inter base body connection 402. By providing one of the membranes 214 with through-holes 228, pressure is partially compensated on both sides of the actuator 212. Thus, the actuator 212 can operate against higher ranges of pressure or a smaller actuation energy is required to close against a predefined pressure at ports 1 or 3. Various configurations of the openings can be used for achieving optimal performance, depending on the pressure required at each port.

As mentioned above, the individual microvalves 200, 500 do not have to be arranged side by side as this is shown in FIGS. 7 to 9, but may also be stacked upon one another. Such a geometry would lead to a much more compact construction of the microvalve manifold 400.

Furthermore, also more than two microvalves may be combined for forming the microvalve array manifold. It is also not necessary that all of the employed actuators use a membrane having through-holes therein.

### REFERENCE NUMERALS

| | |
|---|---|
| 100 | Microvalve |
| 102 | Base body |
| 104 | Cavity |
| 106 | First opening |
| 108 | Second opening |
| 110 | Fluid stream |
| 112 | Actuator |
| 114 | Membrane |
| 116 | First chamber |
| 118 | Second chamber |
| 120 | Actuating element |
| 122 | Piezoelectric drive element |
| 122A, 122B | First and second drive elements |
| 124 | Flexible bearing |
| 126 | Notch |
| 128 | Through-hole |
| 130 | Valve seat |
| 200 | Microvalve |
| 202 | Base body |
| 204 | Cavity |
| 206 | First opening |
| 208 | Second opening |
| 210 | Fluid stream |
| 212 | Actuator |
| 214 | Membrane |
| 216 | First chamber |
| 218 | Second chamber |
| 220 | Actuating element |
| 222 | Piezoelectric drive element |
| 222A, 222B | First and second drive elements |
| 224 | Flexible bearing |
| 226 | Notch |
| 228 | Through-hole |
| 230 | First valve seat |
| 232 | Second valve seat |
| 300 | Microvalve manifold |
| 302 | Fluid path |
| 310 | Fluid stream |
| 400 | Microvalve manifold |
| 402 | Fluid path |
| 410 | Fluid stream |
| 500 | Microvalve |
| 502 | Base body |
| 504 | Cavity |
| 506 | First opening |
| 508 | Second opening |
| 512 | Actuator |
| 514 | Membrane |
| 516 | First chamber |
| 518 | Second chamber |
| 520 | Actuating element |
| 522 | Piezoelectric drive element |
| 522A, 522B | First and second drive elements |
| 524 | Flexible bearing |
| 526 | Notch |
| 530 | First valve seat |

1. A microvalve, comprising:
a base body with a cavity, at least one first opening, and at least one second opening, each of the at least one first opening and the at least one second opening extending into the cavity;
a deflectable membrane, which separates the cavity into a first chamber and a second chamber, the deflectable membrane has at least one through-hole extending between the first chamber and the second chamber; and
an actuating element, which is supported by the base body and contacts the deflectable membrane, the actuating element is operable to deflect the membrane to move between at least two positions.

2. The microvalve according to claim 1, wherein the at least one first opening is arranged to extend into the first chamber and the at least one second opening is arranged to extend into the second chamber.

3. The microvalve according to claim 1, wherein at least one of the at least one first opening and the at least one second opening has a valve seat.

4. The microvalve according to claim 3, wherein the deflectable membrane is operable to contact the valve seat to close the at least one first opening or the at least one second opening in one of the at least two positions.

5. The microvalve according to claim 1, wherein the at least one through-hole is arranged so as to remain unobstructed in all of the at least two positions.

6. The microvalve according to claim 1, wherein the actuating element includes at least one piezoelectric drive element that is ring shaped.

7. The microvalve according to claim 6, wherein the deflectable membrane buckles upon activation of the at least one piezoelectric drive element.

8. The microvalve according to claim 7, wherein the at least one piezoelectric drive element is supported around a peripheral region of the at least one piezoelectric drive element and is moveable.

9. The microvalve according to claim 7, wherein the at least one through-hole is arranged in a region of the deflectable membrane that is not covered by the at least one piezoelectric drive element and is outside a center of the deflectable membrane.

10. The microvalve according to claim 1, wherein the actuating element includes a first piezoelectric drive element and a second piezoelectric drive element, the deflectable membrane is supported between the first piezoelectric drive element and the second piezoelectric drive element.

11. The microvalve according to claim 1, wherein two first openings extend into the first chamber and one second opening extends into the second chamber.

12. The microvalve according to claim 11, wherein the second opening and one of the two first openings opposing the second opening each have a valve seat that is contactable by the deflectable membrane.

13. The microvalve according to claim 12, wherein the at least one through-hole is arranged in a region of the deflectable membrane that does not contact the valve seats.

14. A microvalve array, comprising:
at least one microvalve including:
a base body with a cavity, at least one first opening, and at least one second opening, each of the at least one first opening and the at least one second opening extending into the cavity;
a deflectable membrane, which separates the cavity into a first chamber and a second chamber, the deflectable membrane has at least one through-hole extending between the first chamber and the second chamber; and
an actuating element, which is supported by the base body and contacts the deflectable membrane, the actuating element is operable to deflect the membrane to move between at least two positions.

15. The microvalve array according to claim 14, wherein the at least one microvalve includes a first microvalve and a second microvalve that are interconnected by a fluid path connected to the at least one first opening of each of the first microvalve and the second microvalve.

16. The microvalve array according to claim 15, wherein the at least one first opening of the first microvalve is closable by movement of the deflectable membrane of the first microvalve and the at least one first opening of the second microvalve is closable by movement of the deflectable membrane of the second microvalve.

17. The microvalve array according to claim 15, wherein the first microvalve and the second microvalve each have two second openings, the deflectable membrane of the first microvalve is movable to close either the at least one first opening of the first microvalve or one of the second openings of the first microvalve opposite the at least one first opening, and the deflectable membrane of the second microvalve is movable to close either the at least one first opening of the second microvalve or one of the second openings of the second microvalve opposite the at least one first opening.

18. The microvalve array according to claim 14, wherein the at least one microvalve includes a first microvalve and a second microvalve that are interconnected by a fluid path connected to the at least one second opening of each of the first microvalve and the second microvalve.

19. The microvalve array according to claim 18, wherein the at least one second opening of the first microvalve cannot be closed by movement of the deflectable membrane of the first microvalve and the at least one second opening of the second microvalve cannot be closed by movement of the deflectable membrane of the second microvalve.

20. The microvalve array according to claim 14, further comprising another microvalve having a deflectable membrane without a through-hole.
